(19) United States
(12) Patent Application Publication
(10) Pub. No.: US 2009/0305743 A1
(43) Pub. Date: Dec. 10, 2009

(54) PROCESS FOR RENDERING AT LEAST ONE MULTIMEDIA SCENE

(75) Inventors: Erwann Gouesbet, Saint-Domineuc (FR); Elouan Le Coq, Rennes (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: Streamezzo, Paris (FR)

(21) Appl. No.: 12/296,620

(22) PCT Filed: Apr. 3, 2007
(86) PCT No.: PCT/EP2007/053269

§ 371 Date: Jun. 2, 2009

(30) Foreign Application Priority Data
Apr. 10, 2006 (FR) 0603187

(51) Int. Cl. H04B 1/38; G09G 5/00

(52) U.S. Cl. 455/566; 345/649; 345/169

(57) ABSTRACT

A method is provided for restitution of at least one multimedia scene, having at least two objects, on a display of a radio communication terminal. The method includes: determining an orientation of the display relative to a user; reorganizing the arrangement of the objects constituting the multimedia scene, based on the orientation and on at least one arrangement data present in the scene; and restitution of the reorganized multimedia scene on the viewing device.

### CROSS-REFERENCE TO RELATED APPLICATIONS

This Application is a Section 371 National Stage Application of International Application No. PCT/EP2007/053269, filed Apr. 3, 2007 and published as WO 2007/115983 on Oct. 18, 2007, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of presenting multimedia content on radio communication terminals, for example of the radiotelephone or electronic organizer (Personal Digital Assistant or PDA) type, etc.

More specifically, the disclosure relates to the display of multimedia content, for example of the RichMedia type, on a display device such as a radio communication terminal, for example a screen taking into consideration the orientation of said display device.

By multimedia content, we mean in particular a set composed of at least one animated graphic scene, also called a multimedia scene, formed by a spatiotemporal arrangement of graphic objects.

In this document, we will refer indifferently to multimedia content and multimedia scenes.

Thus, the disclosure can be used in a large number of applications that use a description of a spatiotemporal arrangement of graphic objects to represent the graphic behavior of these applications.

In particular, the disclosure applies to graphic scene description formats already known, such as LASeR (Lightweight Application Scene Representation), MPEG-4/BIFS (Binary Format Scene), SVG (Scalable Vector Graphics), SMIL (Synchronized Multimedia Integration Language), XHTML (eXtensible HyperText Markup Language), and so on.

### BACKGROUND OF THE DISCLOSURE

Throughout the description, the term “display device” will be used to refer to a planar element, such as a screen, making it possible to display multimedia content.

Such a screen can in particular be defined in a Cartesian coordinate system, with a center O corresponding to the lower left-hand corner of the screen with dimension Ox and Oy, where Ox corresponds to a screen length on the x-axis and Oy corresponds to a screen length on the y-axis.

It is considered throughout the description, in a conventional manner, that when the length Ox is greater than the length Oy, the content displayed is in landscape mode, and when the length Oy is greater than the length Ox, the content displayed is in portrait mode.

When the length Ox is equal to the length Oy, the proposed screen is square, and a change in its orientation does not require reorganization of the content.

At present, a number of techniques are known for displaying multimedia content, for example of the RichMedia type, on a display device of a given size.

In particular, as shown in relation to FIGS. 1A and 1B, if we consider, according to these prior art techniques, a screen making it possible to display content in portrait mode (FIG. 1A), a change in orientation of this screen by a 90-degree rotation also leads to an adaptation of the content displayed by a 90-degree rotation, which is in landscape mode (FIG. 1B).

For example, in the case of the adaptation of SVG content in portrait mode and in landscape mode shown in relation to FIGS. 1A and 1B, the multimedia content may be defined as follows:

<svg>
<text def=T1 size=”20” string=”mon titre” pos=.../>
<text def=T2 size=”20” string=”sous titre” pos=.../>
<image def=T3 source= “monImage.jpg” pos=.../>
<text def=T4 size=”14” string=”mon texte de.../>
</svg>

More specifically, according to the prior art, the adaptation performed is only vectorial. These vectorial graphic content reading and design techniques are therefore based on affine calculations for adapting the content to the format of a screen, possibly dynamically.

For example, we know in particular the following two SVG attributes:

the viewBox attribute, which establishes a system of logic coordinates on which the SVG image coordinates are relatively based;

the preserveAspectRatio attribute, which specifies that the rendering ratio must be preserved by placing the image in the available space according to the value of said attribute, by increasing the width or the height to respectively reach the width or the height of the available space, possibly by cutting off overflows.

However, a major disadvantage of these techniques, shown in relation to FIG. 1B, is that they do not take into account a potentially different organization of the content, according to the orientation of the presentation of the content.

In other words, these techniques do not take into account the notion of organization, which nevertheless appears to be fundamental for nominally presenting information both in portrait mode and in landscape mode.

More specifically, certain prior art techniques make it possible to take into account the “portrait” organization, but only by taking into account arrangement conditions requiring the loading of two content items and the application, by the display device or the terminal to which it belongs, numerous rotation calculations, which are very costly in terms of resources, in particular time and memory.

Thus, a major disadvantage of this technique is that the multiplication of content items involves significant complexity, in particular for sequences of multimedia scenes.

### SUMMARY

An aspect of the disclosure relates to a process for rendering at least one multimedia scene, including at least two objects, on display means of a radio communication terminal.

According to an embodiment of the invention, such a process includes:
a step of determining an orientation of said display means with respect to a user;
a step of reorganizing the arrangement of said objects constituting said multimedia scene, according to said orientation and at least one arrangement information item present in said scene;
a step of rendering said multimedia scene reorganized on said display device.

Thus, the rendering process according to an embodiment of the invention takes into account an orientation of display means of the terminal (for example its screen), to rearrange the objects of the scene and thus render the scene optimally for the user.

Preferably, said arrangement information includes at least two sets of instructions, respectively corresponding to:
instructions for arranging said multimedia scene for an orientation in portrait mode, and
instructions for arranging said multimedia scene for an orientation in landscape mode.

Thus, such arrangement information makes it possible, depending on the display context, to render a graphic or multimedia scene, for example on a mobile radio communication terminal, according to said portrait mode or according to the landscape mode. This change from portrait mode to landscape mode, or vice versa, can advantageously be achieved either directly at the level of the scene by means of a software approach, or using hardware, by controlling (for example from the operating system of the terminal) the rotation of the of the screen of the terminal, for example.

Thus, the user can display a multimedia scene optimally arranged according to the orientation of the screen of the terminal, i.e. in a single scene, objects can be placed in different locations according to the mode (portrait or landscape) so as to remain visible.

In an alternative of the process according to an embodiment of the invention, said arrangement information includes at least one instruction for rotation of at least one of said objects, according to an angle depending on said orientation.

Thus, the rearrangement of the objects of the scene can consist of movements of objects and/or rotations of objects according to an angle depending on the orientation of the terminal.

Indeed, while the current ergonomics of screens of most mobile communication terminals are square or rectangular, and, for some, are pivoted so as to enable their rotation about a pin or a swivel joint, the tendency in terms of development of the shape of screens of such terminals is to provide curves in the angles, and even to create an “ovoid” shape. In such a context of development of mobile terminal screen shapes, such an alternative of the process according to an embodiment of the invention is fully justified.

Advantageously, said multimedia scene is described by a description file including at least one information item indicating to said terminal that said multimedia scene is capable of being adapted to a change in orientation of said display means.

Such information is especially technically beneficial in that it can be read by the reader (or “player”) of multimedia scenes, which can, on the basis thereof, activate in the operating system of the terminal, either a display software orientation change, or a terminal screen hardware orientation change, when the terminal has a screen capable of moving in rotation according to at least one direction of rotation.

According to a specific embodiment of the invention, said multimedia scene includes at least one arrangement object, defining said information for arrangement of said scene.

Thus, the arrangement information is grouped in an arrangement object, which will be “activated” after determining an orientation of the display means, and which will then itself activate the appropriate arrangement instructions.

Preferably, said step of determining an orientation takes into account a command to modify the orientation of said display means.

Thus, the display means receive a command, for example upon an action by the user (key press, voice command, etc.) wanting to modify the orientation of the terminal, and transmit it to the rendering process according to an embodiment of the invention, which will then take it into account to determine the orientation of the display means.

In such an embodiment of the process according to the invention, the rotation of the screen of the terminal is first initiated, for example upon an action by the user, at the end of which rotation the rearrangement of the scene is achieved and the display is then rendered according to the orientation desired or initiated by the terminal.

In particular, the change in orientation can be from portrait mode to landscape mode or vice versa.

According to another alternative of the process, said step of determining an orientation takes into account a request to change the orientation, transmitted by said multimedia scene to said terminal.

In this embodiment of the invention, the request is transmitted directly by the multimedia scene, of which the content and/or the description file includes the information necessary to initiate a change in orientation of the display device (for example the screen of the terminal).

Again, the change in orientation may be from portrait mode to landscape mode or vice versa.

According to yet another alternative, said step of determining an orientation takes into account a detection by said terminal of a change in orientation of said display means.

In this alternative of the process according to an embodiment of the invention, said step of activating a command to modify the orientation is executed after detection by said terminal of a change in its orientation from a portrait mode to a landscape mode, or from a landscape mode to a portrait mode. Indeed, many mobile radio communication terminals, or other personal digital assistants (PDA) or pocket computers (pocket PCs) have a screen that can be orientated by rotating in one or more directions.

Thus, these types of terminals targeted by the process according to an embodiment of the invention have an operating system capable of detecting any modification in the orientation of the display device (the screen). In the context of an embodiment of this invention, this involves taking into account events affecting the modifications of the orientation of the screen (for example a quarter-turn rotation to the right or to the left) and on the basis of such events, initiating the modification or the adaptation of the arrangement of the objects forming the multimedia scene.

Advantageously, the process according to an embodiment of the invention includes a step of modifying the action of at least one key of a keypad of said terminal, according to said orientation.

Indeed, when the keys of a keypad forming the human-machine navigation interface are associated with objects of a multimedia scene displayed according to a landscape mode, it is suitable when changing the orientation of the screen of a terminal, or of the display zone on said screen, to consequently modify the keys of the keypad that should interact with the same objects having been subjected to a change in orientation.

Preferably, said multimedia scene is encoded by means of a graphic animation description of the type belonging to the group including:
LASeR;
MPEG-4/BIFS;
SVG;
SMIL;
XHTML.

In particular, said multimedia scene can be encoded by means of a graphic animation description complying with ISO/IEC standard 14496-20 or MPEG-4 LASeR.

An embodiment of the invention also relates advantageously to the computer program that can be downloaded from a communication network and/or stored on a medium that is computer-readable and/or executable by a microprocessor, including program code instructions for implementing the process for rendering at least one multimedia scene, including at least two objects, on display means of a terminal, as mentioned above.

An embodiment of the invention also relates advantageously to a signal for describing a multimedia scene including a set of objects capable of being rendered on display means of a terminal.

According to an embodiment of the invention, such a signal includes at least one arrangement information item including at least two types of instructions, including:
instructions for arranging said multimedia scene for an orientation in portrait mode, and
instructions for arranging said multimedia scene for an orientation in landscape mode.

so as to enable a terminal to adapt the mode of rendering of said multimedia scene on said display means according to said at least one arrangement information item and a determined orientation of said display means.

Advantageously, such a signal includes at least one arrangement object defining said arrangement information.

An embodiment of the invention also relates to a radio communication terminal including display means and means for rendering, on said display means, at least one multimedia scene, in which said terminal also includes means for controlling and/or interacting with at least some of the objects constituting said at least one multimedia scene.

Preferably, such a terminal and/or the multimedia scene reader equipping it, includes means for determining an orientation of said display means and means for reorganizing the arrangement of said objects constituting said at least one multimedia scene to be rendered on said display means, in which said reorganization means take into account at least one arrangement information item known from said multimedia scene, and the determined orientation of said display means.

Advantageously, said arrangement information includes at least two sets of instructions, corresponding respectively to:
instructions for arranging said multimedia scene for an orientation in portrait mode, and
instructions for arranging said multimedia scene for an orientation in landscape mode.

Preferably, said reorganization means take into account at least one arrangement object defining said arrangement information.

An embodiment of the invention also relates to a process for constructing at least one multimedia scene, including at least two objects, intended to be rendered on display means of a radio communication terminal.

According to the invention, such a construction process includes a step of defining at least one arrangement information item including at least two sets of instructions, corresponding respectively to:
instructions for arranging said multimedia scene for an orientation in portrait mode, and
instructions for arranging said multimedia scene for an orientation in landscape mode.

so as to enable a terminal to adapt the mode of rendering of said multimedia scene on said display means according to said at least one arrangement information item and a determined orientation of said display means.

Advantageously, said definition step includes a sub-step of creating an arrangement object defining said arrangement information.

### BRIEF DESCRIPTION OF THE DRAWINGS

Other features and advantages will become clearer on reading the following description of a specific embodiment, given by way of a simple illustrative and non-limiting example, and the appended drawings, in which:

FIGS. 1A and 1B show the adaptation of SVG content in portrait and landscape modes according to the prior art;

FIGS. 2A and 2B show the adaptation of SVG content in portrait and landscape modes according to an embodiment of the invention;

FIGS. 3A and 3B show an example of LASeR content requesting the adaptation of the orientation of the screen to the multimedia content according to an embodiment of the invention;

FIGS. 4A, 4B, 4C and 4D show another aspect of an embodiment of the invention making it possible to adapt the navigation to a new orientation of a display device;

FIG. 5 shows the main steps of the rendering process according to a specific embodiment of the invention.

### DETAILED DESCRIPTION OF ILLUSTRATIVE EMBODIMENTS

### 1. General Principle

The general principle of an embodiment of the invention is based on the use of arrangement information, known from the multimedia content, making it possible to reorganize the multimedia content to be displayed by taking into account the orientation of the display device or a desired orientation by the content.

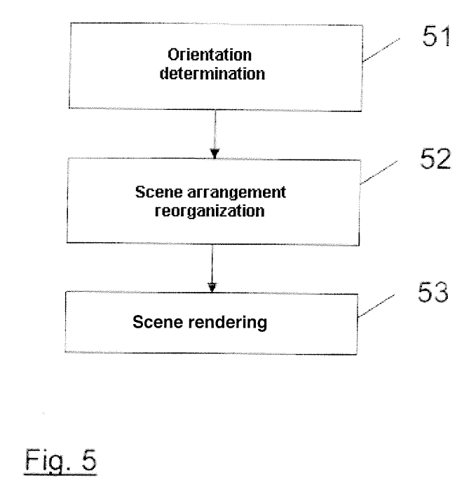

The main steps of the rendering process according to an embodiment of the invention are presented in relation to FIG. 5.

The first step 51 of determining an orientation consists of determining the orientation of the means for displaying the multimedia scene on the terminal, by the screen of the terminal.

The determination of the orientation of the screen of the terminal can be done upon receiving a command to modify the orientation, received by the screen itself. This command can, for example, be generated by a key press by the user on a button dedicated to changing the orientation of the screen, or upon a voice command given by the user.

The determination of the orientation can also take into account a modification of the orientation of the screen by the user, who turns the screen directly as he/she wishes.

Finally, a modification of the orientation of the screen can also be ordered on the initiative of the multimedia scene itself, which indicates to the terminal that a modification of the orientation of the terminal is desired.

Then, in step 52 of reorganizing the arrangement of objects constituting the multimedia scene, the process according to an embodiment of the invention takes into account the orientation determined in the previous step and at least one arrangement information item present in the multimedia scene making it possible to modify the arrangement of the objects of the scene.

The activation, or the implementation, of this arrangement information makes it possible to move, or simply rotate, certain objects of the scene, so as to give the rendering optimal for the user, regardless of the orientation of the screen of the terminal.

Once the scene has been reorganized, it is rendered on the screen in rendering step 53.

### 2. Specific Embodiment

Below is a specific embodiment of the invention, according to which a radio communication terminal, for example a radio telephone, makes it possible to display multimedia content on a display device integrated in the terminal, a screen according to this particular embodiment, so that the content, for example of the RichMedia type, can be adapted to changes in orientation of the screen on which it is presented.

An embodiment of the invention thus proposes, according to this specific embodiment, a technique making it possible to optimally present content on a display device of which the orientation may vary.

The radio communication terminal therefore includes means for determining the orientation of the display device, or of the content displayed.

In particular, according to this specific embodiment described, the content includes an indicator (signal) informing the terminal that it is capable of adapting to a change in orientation of the screen. The designer of content can thus signal that the content is “Screen Orientation Aware”.

The invention also makes it possible, according to an alternative embodiment, to take into account the orientation of the screen so as to best adapt the means for interaction (for example a keypad) with the graphic objects of the multimedia content, in order to adapt the navigation to a new orientation of the display device.

According to another alternative embodiment, the invention makes it possible to indicate to the display device the orientation most suitable for the content to be displayed.

It is indeed noted that the choice of presentation of multimedia content to be displayed has a strong impact on the performance of a terminal, because it makes it possible to leave the rotation of the graphic objects to the hardware device, rather than using a software approach.

Indeed, the terminals with orientable screens assume this functionality by low-level routines. This alternative of the invention therefore makes it possible to use these routines rather than to perform software rotations, which are more costly in terms of resources.

Below, in relation to FIGS. 2A and 2B, a screen is presented that makes it possible to display content in portrait mode (FIG. 2A) and the same content in landscape mode (FIG. 2B) after a change in orientation of said screen by a 90-degree rotation, according to the specific embodiment described below.

According to this embodiment, the multimedia content to be displayed on the screen has at least one information item on the arrangement of said content.

To do this, the creator of multimedia content designs a presentation and its logical application. The creator then determines an inactive block of instructions for arrangement of the multimedia content for an orientation in portrait mode, and an inactive block of instructions for arrangement of the multimedia content for an orientation in landscape mode. The creator can then signal the content as being “Screen Orientation Aware”, i.e. as having the ability to adapt to changes in orientation of the display device, by referencing the two arrangements.

Thus, when reading the multimedia content, the radio communication terminal can take into account the Screen Orientation Aware property of the content, and activate the arrangement instruction block for the current mode (portrait or landscape).

If there is a change in the orientation of the display device, the terminal can update the organization of the content, by activating the corresponding arrangement instruction block.

According to an alternative embodiment, it is also possible for the content designer to assign a request to change orientation to an interaction.

Thus, if it is capable of taking into account this request when activated, the terminal can launch the orientation order to the display screen, causing a rotation of the content, according to this orientation request.

If the order is accepted, the steps described above apply, and the content is notified of the change in orientation.

Thus, two commands specific to the ability of the content to adapt to changes in screen orientation are defined: a first specifying that the content is “screen orientation aware”, and a second giving in reference the two conditional instruction blocks, and a specific command related to the orientation change requests, which command specifies the required mode (portrait or landscape).

Below, purely by way of illustration, an example of the syntax and semantics proposed for these commands is provided:

cmd://ScreenOrientaitonAware?portrait=”PortraitActivation”&landscape=”Landscape Activation”

cmd://SetScreenOrientation?orientation=”Portrait”|“Landscape”

Thus, according to this specific embodiment of the invention, signaling blocks are used for notifications, and conditional organization instruction blocks define the arrangement of the graphic objects of the multimedia content.

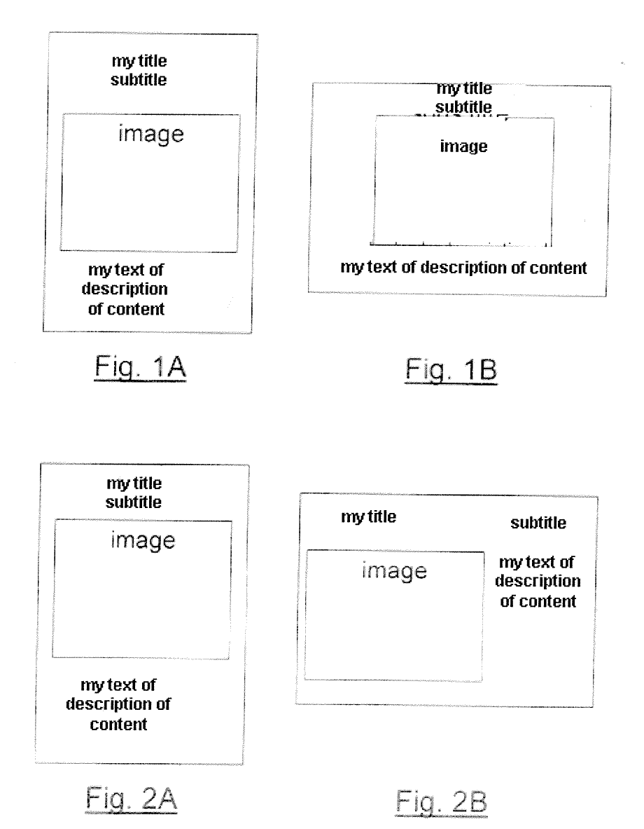

More specifically, in reference again to FIGS. 2A and 2B, it is noted that the implementation of the technique according to an embodiment of the invention allows for better organization of the content according to the orientation of the screen, compared with the techniques of the prior art, as shown in particular in FIGS. 1A and 1B. Thus, the content shown in relation to FIGS. 2A and 2B is adapted, including the organization of its components.

For example, in the context of the adaptation of SVG content in portrait mode and in landscape mode shown in relation to FIGS. 2A and 2B, the multimedia content may be defined as follows:

<svg>
<ScreenOrientationAware portrait=”P” landscape=”L”>
<text def=T1 size=”20” string=”mon titre” pos=.../>
<text def=T2 size=”20” string=”mon titre” pos=.../>
<image def=T3 source= “monImage.jpg” pos=.../>
<text def=T4 size=”14” string=”mon texte de.../>
<script def=”P”>
T1.setposition(...); T2.setposition(...);
T3.setposition(...); T4.setposition( );viewport.set( );
</script>
<script def=”L”>
T1.setposition(...); T2.setposition(...);
T3.setposition(...); T4.setposition( );viewport.set( );
</script>
</svg>

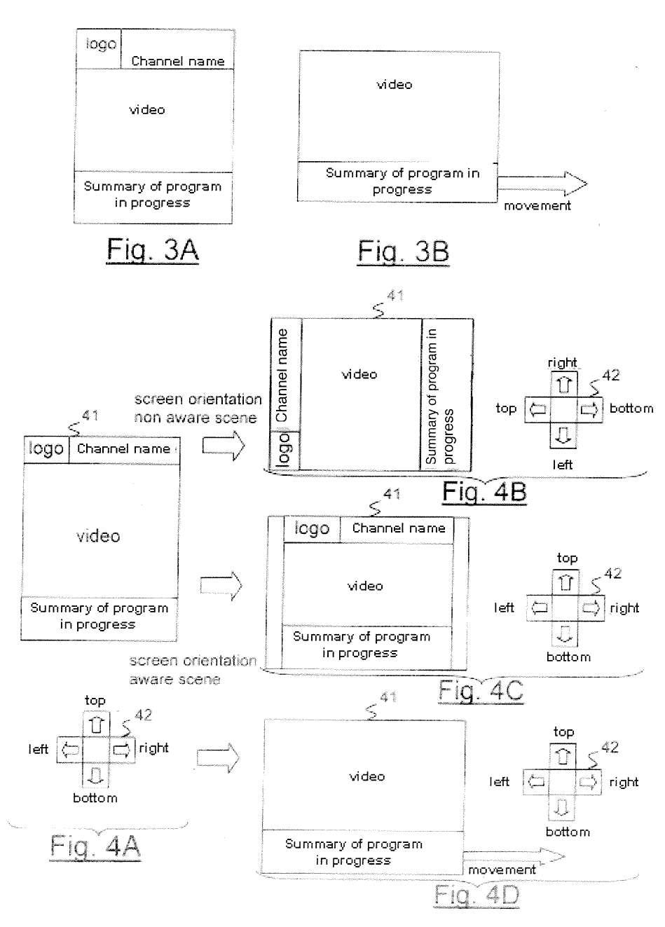

An example of content requesting the adaptation of the orientation of the screen to the multimedia content is also presented in relation to FIGS. 3A and 3B.

More specifically, according to this example, the scene wants to change orientation, and asks the terminal to orient the content either in portrait mode or in landscape mode. The terminal then notifies the scene when the change in orientation has been completed.

Thus, according to this example embodiment, the content is designated by its designer in order to request the adaptation of the screen to the new organization.

For example, in the context of the adaptation of content in portrait mode and in landscape mode shown in relation to FIGS. 3A and 3B, the multimedia content may be defined as follows:

<scene>
<a url=”cmd://ScreenOrientationAware?portrait=P&landscape=L”>
<item logo/>
<item chaine/>
<item video/>
<item resume/>
<a fullscreen url=”cmd://ScreenOrientation?mode= landscape”/>
<a normal url=”cmd://ScreenOrientation?mode= portrait”/>
<conditional L>
video.scaleup;logo.hide;chaine.hide/;resume.anim;fullscreen.hide;normal.show;
</conditional>
<conditional P>
video.scaledown;logo.show;chaine.show;resume.animback;fullscreen.show;normal.hide;
</conditional>
</scene>

Thus, as indicated above, the conditional adaptation blocks are executed if the request is successfully executed, i.e. if the terminal is capable of taking into account this request to change orientation. If not, i.e. if the terminal cannot manage a change in orientation of the display device, the presentation remains the same, which means that the content displayed remains unchanged.

An alternative is also envisaged in which the author of the content specifies the execution of a more costly arrangement block (in particular in terms of rotation of graphic objects) upon launching of the request, and switches to optimal mode as described above only if it succeeds.

An alternative embodiment of the invention in which a radio communication terminal also includes means for interaction with graphic objects of the multimedia content will now be presented in relation to FIGS. 4A to 4D.

This alternative embodiment is considered in particular only if the orientation of the screen takes into account only “portrait” and “landscape” orientations; however, it is preferable for the application of an embodiment of the invention to also take into account “right-handed landscape” and “left-handed landscape” modes depending on whether the screen has been subjected to a 90-degree rotation to the right or to the left.

As already indicated, the main objective of an embodiment of the invention is to reorganize the presentation of the various content information according to the orientation of the display device.

It can be noted in particular that this reorganization is identical from the perspective of content whether one is in “right-handed landscape” or “left-handed landscape”.

However, for the radio communication terminal, it is preferable to more precisely take into account the orientation of the content, so as to best adapt the means for interaction with the graphic objects of the multimedia content, for example a keypad.

More specifically, in relation to FIG. 4A, a communication terminal including a screen 41 and a keypad 42 is considered.

As shown in FIG. 4A, the terminal is considered to be in the vertical position, i.e. the screen and the keypad are in the same vertical plane, and the content displayed is in portrait mode.

The functioning of the keys of the keypad is, for example, defined as follows: the “up” command corresponds to the 2 key of the keypad, the “down” command corresponds to the 8 key, the “right” command corresponds to the 6 key and the “left” command corresponds to the 4 key.

Also, in relation to FIGS. 4B, 4C and 4D, it is considered that the terminal is rotated 90 degrees, and is therefore in the horizontal position, i.e. the screen and the keypad are in the same horizontal plane.

In a first case, shown in relation to FIG. 4B, the content does not have “screen orientation aware” signaling.

Consequently, the terminal does not modify the functioning of the keys of the keypad. For example the “up” command remains the 2 key of the keypad, the “down” command remains the 8 key, the “right” command remains the 6 key and the “left” command remains the 4 key.

In a second case, shown in relation to FIG. 4C, the content has the “screen orientation aware” signaling.

Consequently, if the terminal has been rotated 90 degrees to the right (i.e. a change to “right-handed landscape”), the “up” hardware key (2 key) must be signaled as the “left” hardware key to the content (4 key).

In other words, the “up” command must be signaled as the 4 key of the keypad, the “down” command becomes the 6 key, the “right” command becomes the 2 key and the “left” command becomes the 8 key.

Conversely, if the terminal has been rotated 90 degrees to the left (i.e. a change to “left-handed landscape”), the “up” hardware key (2 key) must be signaled as the “right” hardware key to the content (6 key).

In other words, the “up” command must be signaled as the 6 key of the keypad, the “down” command becomes the 4 key, the “right” command becomes the 8 key and the “left” command becomes the 2 key.

The same applies in the third case, shown in relation to FIG. 4D, in which the content has the “screen orientation aware” signaling and requests the adaptation of the screen to the content.

The orientation of the screen is thus taken into account to best adapt the interactions commanded by the keypad.

An embodiment of the invention thus proposes a technique for improving the organization of various information items contained by multimedia content, when this content is displayed on a display device of a radio communication terminal.

An embodiment of the invention provides such a technique taking into account a different organization of the content, desired by the content designer, according to the orientation of the presentation of said content.

According to this embodiment, the organization of the content is therefore defined unitarily in each content item, thus enabling the content designer to choose the presentation mode.

Thus, the notion of organization is left entirely free to the content designer by the use of an embodiment of the invention.

Another aspect of an embodiment of the invention relates to a radio communication terminal being equipped with means for interaction with graphic objects of the multimedia content scenes, for example a keypad. Such a technique makes it possible to adapt the navigation using the interaction means to a new orientation of the display device.

Finally, an embodiment of the invention proposes such a technique having better performance than the prior art.

Although the present disclosure has been described with reference to one or more examples, workers skilled in the art will recognize that changes may be made in form and detail without departing from the scope of the disclosure and/or the appended claims.

1. Process for rendering at least one multimedia scene, including at least two objects, on a display of a radio communication terminal, wherein the process includes:
a step of determining an orientation of said display with respect to a user;
a step of reorganizing an arrangement of said objects constituting said multimedia scene, according to said orientation and at least one arrangement information item present in said scene;
a step of rendering said multimedia scene reorganized on said display device.

2. Process for rendering at least one multimedia scene according to claim 1, wherein said arrangement information includes at least two sets of instructions, respectively corresponding to:
instructions for arranging said multimedia scene for an orientation in portrait mode, and
instructions for arranging said multimedia scene for an orientation in landscape mode.

3. Process for rendering at least one multimedia scene according to claim 1, wherein said arrangement information includes at least one instruction for rotation of at least one of said objects, according to an angle depending on said orientation.

4. Process for rendering at least one multimedia scene according to claim 1, wherein said multimedia scene is described by a description file including at least one information item indicating to said terminal that said multimedia scene is capable of being adapted to a change in orientation of said display.

5. Process for rendering at least one multimedia scene according to claim 1, wherein said multimedia scene includes at least one arrangement object, defining said information for arrangement of said scene.

6. Process for rendering at least one multimedia scene according to claim 1, wherein said step of determining an orientation takes into account a command to modify the orientation of said display.

7. Process for rendering at least one multimedia scene according to claim 1, wherein said step of determining an orientation takes into account a request to change the orientation, transmitted by said multimedia scene to said terminal.

8. Process for rendering at least one multimedia scene according to claim 1, wherein said step of determining an orientation takes into account a detection by said terminal of a change in orientation of said display.

9. Process for rendering at least one multimedia scene according to claim 1, wherein the process includes a step of modifying an action of at least one key of a keypad of said terminal, according to said orientation.

10. Process for rendering at least one multimedia scene according to claim 1, wherein said multimedia scene is encoded by a graphic animation description of the type belonging to the group including:
LASeR;
MPEG-4/BIFS;
SVG;
SMIL;
XHTML.

11. Computer program stored on a medium that is computer-readable and including program code instructions for implementing a process for rendering at least one multimedia scene, including at least two objects, on a display of a radio communication terminal, when the product is executed by a processor, wherein the process includes:
a step of determining an orientation of said display with respect to a user;
a step of reorganizing an arrangement of said objects constituting said multimedia scene, according to said orientation and at least one arrangement information item present in said scene;
a step of rendering said multimedia scene reorganized on said display device.

12. A process comprising:
generating a signal describing a multimedia scene including a set of objects capable of being rendered on a display of a terminal, wherein the signal includes at least one arrangement information item including at least two types of instructions, including:
instructions for arranging said multimedia scene for an orientation in portrait mode, and
instructions for arranging said multimedia scene for an orientation in landscape mode,
so as to enable a terminal to adapt a mode of rendering of said multimedia scene on said display according to said at least one arrangement information item and a determined orientation of said display; and
transmitting the signal.

13. The process according to claim 12, wherein the signal includes at least one arrangement object defining said arrangement information.

14. Radio communication terminal including:
a display; and
means for rendering, on said display, at least one multimedia scene;
means for controlling and/or interacting with at least some objects constituting said at least one multimedia scene, including:
means for determining an orientation of said display, and
means for reorganizing an arrangement of said objects constituting said at least one multimedia scene to be rendered on said display, in which said reorganization means take into account at least one arrangement information item known from said multimedia scene, and the determined orientation of said display.

15. Radio communication terminal according to claim 14, wherein said arrangement information includes at least two sets of instructions, corresponding respectively to:
instructions for arranging said multimedia scene for an orientation in portrait mode, and
instructions for arranging said multimedia scene for an orientation in landscape mode.

16. Radio communication terminal according to claim 14, wherein said reorganization means take into account at least one arrangement object defining said arrangement information.

17. Process for constructing at least one multimedia scene, including at least two objects, intended to be rendered on a display of a radio communication terminal, wherein the process includes:
a step of defining at least one arrangement information item including at least two sets of instructions, corresponding respectively to:
instructions for arranging said multimedia scene for an orientation in portrait mode, and
instructions for arranging said multimedia scene for an orientation in landscape mode,
so as to enable a terminal to adapt a mode of rendering said multimedia scene on said display according to said at least one arrangement information item and a determined orientation of said display.

18. Process for constructing at least one multimedia scene according to claim 17, wherein said step of defining includes a sub-step of creating an arrangement object defining said arrangement information.
